(19) United States
(12) Patent Application Publication
(10) Pub. No.: US 2026/0222817 A1
(43) Pub. Date: Jul. 30, 2026

(54) METHOD FOR UE LOCATION DETERMINATION BASED ON CELLULAR CONNECTION

(71) Applicant: Telefonaktiebolaget LM Ericsson (publ), Stockholm (SE)

(72) Inventors: Jonathan LYNAM, San Jose, CA (US); Dmitri KRYLOV, Sunnyvale, CA (US); Lars ERNSTROM, Mountain View, CA (US); Joel L. WITTENBERG, El Cerrito, CA (US)

(73) Assignee: Telefonaktiebolaget LM Ericsson (publ), Stockholm (SE)

(21) Appl. No.: 19/140,102

(22) PCT Filed: Dec. 19, 2022
(86) PCT No.: PCT/IB2022/062501

§ 371 Date: Jun. 17, 2025

(51) Int. Cl. H04W 12/122; H04W 8/22; H04W 12/06; H04W 12/63

(52) U.S. Cl. CPC H04W 12/122; H04W 8/22; H04W 12/06; H04W 12/63

(57) ABSTRACT

Embodiments include methods, electronic device, and storage medium to verify user equipment (UE) location based on a secured cellular connection. In one embodiment, a method is to be implemented in an electronic device, and comprises: establishing a secured connection over a cellular network between the electronic device and a user equipment (UE) for which a service is to be provided; verifying that an Internet Protocol (IP) address of the UE, through which the secured connection is established in the cellular network, matches a registered IP address of the UE in the cellular network; receiving a location verification request corresponding to the service, the location verification request indicating a location of the UE that has been provided by the UE; and responsive to the location verification request, providing an indication for matching the location of the UE with a registered location for the UE in the cellular network.

### TECHNICAL FIELD

Embodiments of the invention relate to the field of wireless networking and more specifically, to user equipment (UE) location determination based on a cellular connection.

### BACKGROUND ART

An online application store may sell applications for different prices depending on the purchaser's location (usually country or region) for marketing reasons. This can be used to adjust prices to compensate for differences in consumers' disposable income. If a malicious user can successfully falsify their location information to the online application store, then they may be able to fraudulently obtain these goods or services at a price lower than the one to which they are entitled.

Several verification systems have been developed to prevent the user's attempts to falsify their location and to validate the user's asserted location. Yet none of the verification systems leverage information from the cellular network about the user's corresponding user equipment (UE) to determine the user location.

### SUMMARY OF THE INVENTION

Embodiments include methods, electronic device, and storage medium to verify user equipment (UE) location based on a secured cellular connection. In one embodiment, a method is to be implemented in an electronic device, comprising: establishing a secured connection over a cellular network between the electronic device and a user equipment (UE) for which a service is to be provided; verifying that an Internet Protocol (IP) address of the UE, through which the secured connection is established in the cellular network, matches a registered IP address of the UE in the cellular network; receiving a location verification request corresponding to the service, the location verification request indicating a location of the UE that has been provided by the UE; and responsive to the location verification request, providing an indication for matching the location of the UE with a registered location for the UE in the cellular network.

In one embodiment, an electronic device comprises a processor and machine-readable storage medium that provides instructions that, when executed by the processor, are capable of causing the processor to perform: establishing a secured connection over a cellular network between the electronic device and a user equipment (UE) for which a service is to be provided; verifying that an Internet Protocol (IP) address of the UE, through which the secured connection is established in the cellular network, matches a registered IP address of the UE in the cellular network; receiving a location verification request corresponding to the service, the location verification request indicating a location of the UE that has been provided by the UE; and responsive to the location verification request, providing an indication for matching the location of the UE with a registered location for the UE in the cellular network.

In one embodiment, a machine-readable storage medium provides instructions that, when executed by a processor, are capable of causing the processor to perform: establishing a secured connection over a cellular network between the electronic device and a user equipment (UE) for which a service is to be provided; verifying that an Internet Protocol (IP) address of the UE, through which the secured connection is established in the cellular network, matches a registered IP address of the UE in the cellular network; receiving a location verification request corresponding to the service, the location verification request indicating a location of the UE that has been provided by the UE; and responsive to the location verification request, providing an indication for matching the location of the UE with a registered location for the UE in the cellular network.

Embodiments of the invention verify a UE location based on a cellular connection in a cellular network. The location information may be retrieved from the cellular network (e.g., through Network Exposure Function/Service Capability Exposure Function (NEF/SCEF) Monitoring Events (MONTE) Location services) to determine/verify the UE location. This is much more difficult to spoof than prior approaches since it relies on location information provided by the cellular network.

### BRIEF DESCRIPTION OF THE DRAWINGS

The invention may best be understood by referring to the following description and accompanying drawings that are used to illustrate embodiments of the invention. In the drawings:

FIG. 1 illustrates service interdependency in a service topology.

FIG. 2 illustrates the flow to verify user equipment (UE) location based on a secured cellular connection per some embodiments.

FIG. 3 illustrates the flow to verify user equipment (UE) location based on a transport layer security (TLS) cellular connection per some embodiments.

FIG. 4 illustrates a response from Network Exposure Function/Service Capability Exposure Function (NEF/SCEF) Monitoring Events (MONTE) per some embodiments.

FIG. 5 is a flow diagram illustrating the operations to verify user equipment (UE) location based on a secured cellular connection per some embodiments.

FIG. 6 illustrates an electronic device implementing adaptive fault remediation per some embodiments.

FIG. 7 illustrates an example of a communication system per some embodiments.

FIG. 8 illustrates a UE per some embodiments.

FIG. 9 illustrates a network node per some embodiments.

FIG. 10 is a block diagram of a host, which may be an embodiment of the host of FIG. 7, per various aspects described herein.

FIG. 11 is a block diagram illustrating a virtualization environment in which functions implemented by some embodiments may be virtualized.

FIG. 12 illustrates a communication diagram of a host communicating via a network node with a UE over a partially wireless connection per some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### Techniques for User Location Determination

User location determination in a mobile environment is a prerequisite for many applications. For example, location-based service (LBS) provides services or information to users based on user location information. LBS may be used in a variety of context, including navigation, social networking, advertising, and tracking.

Because of the wide usage of user location information, fraudsters have concocted numerous schemes to provide fake user location information in a mobile environment. Buying and using applications through an online application store is a well-known location-based service. Deceiving online application stores is particularly lucrative to fraudsters who fake out user location because the application stores typically adjust prices to the disposable incomes of different locales, yet providers of the application stores and the application developer often lack the resources to verify a user's asserted location efficiently. Interacting with an application store online is used as an example of the LBS that may use embodiments of the invention, but other LBS may implement these embodiments as well.

An application store may use several ways to verify a user's asserted location. When a user starts a purchase from an Application Store Cloud Server (AS-CS), the corresponding UE Application Store client (AS-UE) may first query the UE Operating System (OS) for the UE's Mobile Station International Subscriber Directory Number (MSISDN), Global Positioning System (GPS) location, and/or Internet Protocol (IP) address to determine the user's location to confirm whether it matches the user's asserted location.

Yet these measures can be circumvented by a determined fraudster, who may fake the location information through one or more of the following ways: (1) intercepting the Application Programming Interface (API) requests to the UE OS by the AS-UE to return fake MSISDN and/or fake GPS; (2) using a Virtual Private Network (VPN) to pretend to be in a different country, so that the UE obtains an IP address corresponding to the chosen region to deceive the geographical IP-based location verification; (3) using an illicitly purposed hardware or software GPS device to report a fraudulent location.

To prevent such circumvention, a location verification system may send a verification code via Short Message/Messaging Service (SMS) to the user's phone number. The phone number directly indicates a country, and validating the code (e.g., receiving the code and entering it into an online form) indicates that the user possesses the phone. Yet such system may be compromised too. A fraudster may supply a valid phone number of a co-conspirator in the chosen country, who then provides the received verification code to the fraudster.

Another possible verification approach uses a UE identifier (ID). The Hypertext Transfer Protocol (HTTP) header enrichment has been used to add MSISDN or International Mobile Subscriber Identity (IMSI) in the additional HTTP headers. Mobile service providers have used this technique for traffic optimization and for advertisement purposes. In cellular network communication, this information theoretically could also be used for a better detection of faked request data. However, using the UE ID in this way has been deemed as breaching user privacy and is illegal in some jurisdictions.

None of these verification approaches attempts to obtain user location information stored in the cellular network through which the UE communicates. Yet the user information stored in the cellular network is reliable, as it often comes from user registration, and serves as the basis of charging the user regularly (e.g., monthly). Embodiments of the invention propose a system/method/computer program that may obtain user location information from the cellular network, and such embodiments may be used to verify the user location on their own, or they may be used along with the earlier verification approaches to confirm user location.

### UE Location Determination Based on Cellular Connection

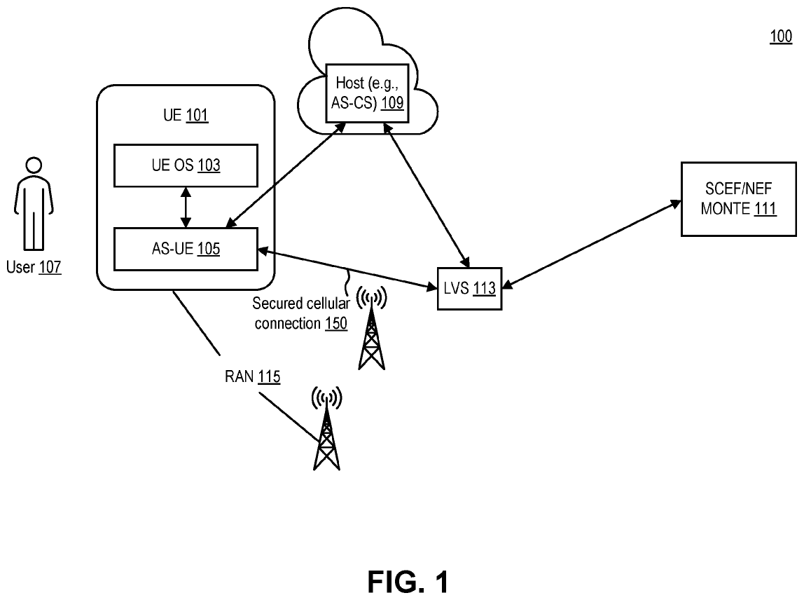

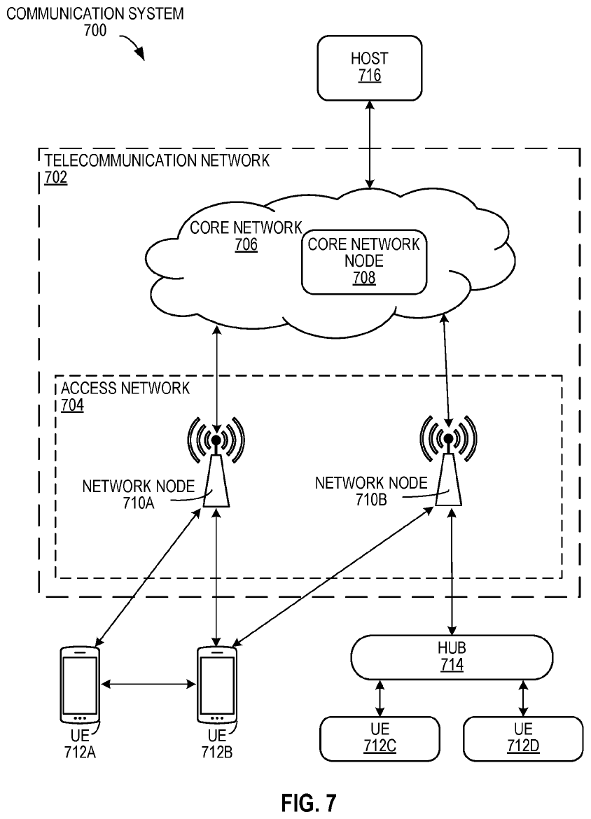

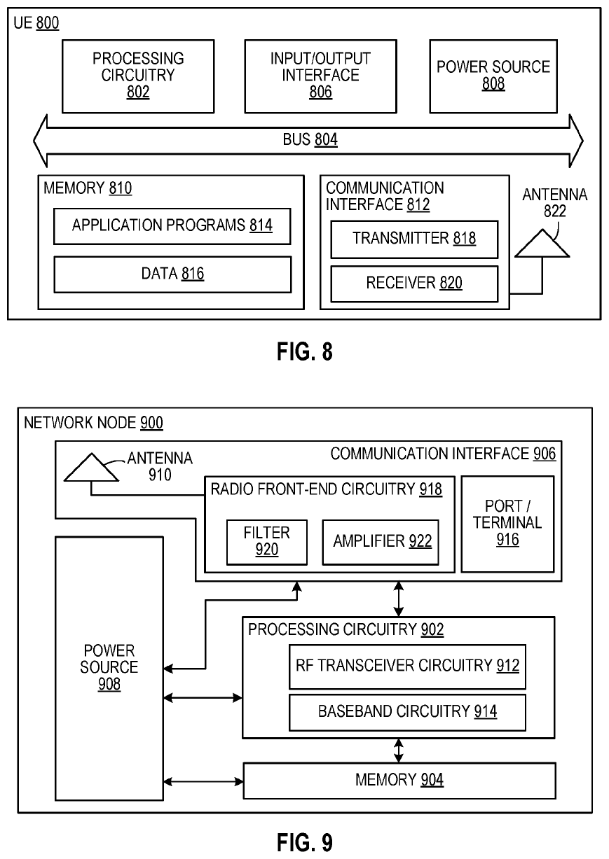

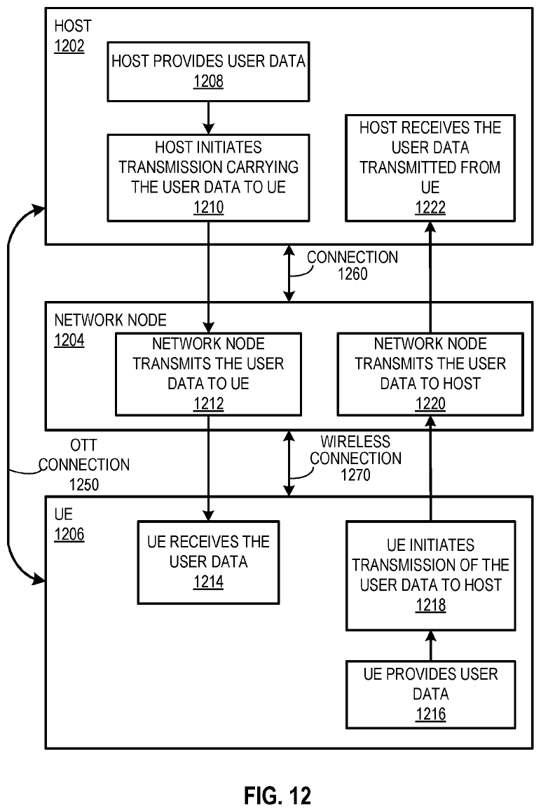

FIG. 1 illustrates an architecture to determine user equipment (UE) location based on cellular connection per some embodiments. System 100 includes a cellular network through which a user 107 uses a UE 101 to communicate with another user or run one or more applications supported by UE 101 and/or the cellular network. UE 101 may be one of UEs 712A to 712D of FIG. 7, UE 800 of FIG. 8, and 1206 of FIG. 12 in some embodiments.

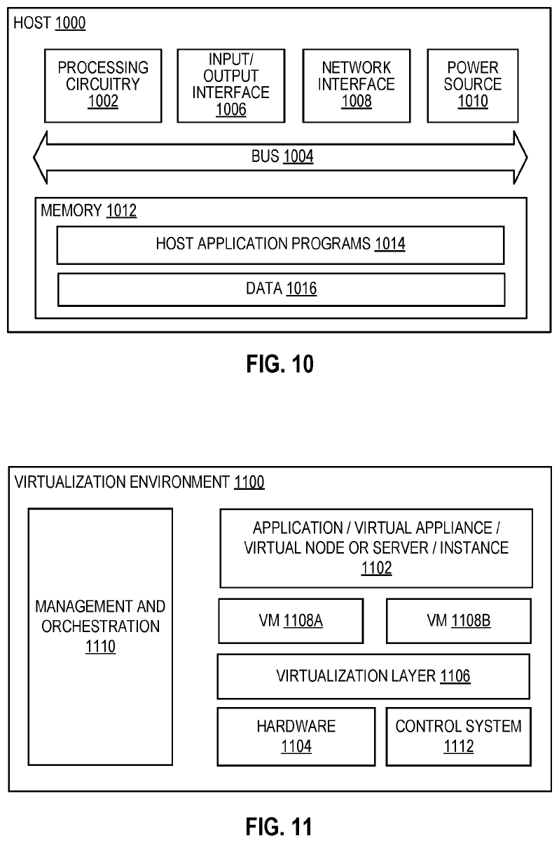

The cellular network includes a radio access network (RAN) 115 and a host 109. RAN 115 may be the telecommunication network 702 of FIG. 7 in some embodiments. Host 109 may be one of host 716 of FIG. 7, host 1000 of FIG. 10, and host 1202 of FIG. 12 in some embodiments. Host 109 implements an Application Store Cloud Server (AS-CS) that operates an application store in some embodiments. Alternatively, the AS-CS may be implemented in an electronic device that is independent from the cellular network thus outside of host 109.

System 100 includes a Network Exposure Function/Service Capability Exposure Function (NEF/SCEF) Monitoring Events (MONTE) module 111 of the cellular network. SCEF is a part of the fourth generation (4G) long-term evolution (LTE) Packet Core and is used to offer APIs to external applications, while NEF has the same/similar role in the fifth generation (5G) Core. Exemplary services offered by SCEF/NEF include location and connectivity monitoring and quality-of-service (QoS). SCEF/NEF MONTE 111 may include an API that provides user information that may be used to determine the UE location and IP address information, given a UE ID. In some embodiments, SCEF/NEF MONTE 111 is implemented in a network node, which may be one of network nodes 710A-710B or 708 of FIG. 7, network node 900 of FIG. 9, and network node 1204 of FIG. 12 in some embodiments.

A naïve approach would allow the AS-CS to directly query SCEF/NEF MONTE 111 for the user information and determine the user location. Yet such query without a user's consent invades the user's privacy. To protect a user's privacy from the operator of the application store, system 100 implements a location verification server (LVS) 113 between the AS-CS and the cellular network to perform the service to verify a user's asserted location, without allowing the application store from direct access to SCEF/NEF MONTE 111 to learn information more than required to verify the user's asserted location. By implementing LVS 113, system 100 protects a user's privacy while allowing an application store to verify the user location based on reliable user location information stored in a cellular network.

In some embodiments, LVS 113 may be implemented in a network node, which implements SCEF/NEF MONTE 111 or is coupled to the network node implementing SCEF/NEF MONTE 111. Alternatively, LVS 113 may be implemented in an electronic device that is independent from the cellular network and communicates with SCEF/NEF MONTE 111.

UE 101 includes a UE OS 103 and a UE Application Store client (AS-UE) 105. AS-UE 105 may communicate with the Application Store Cloud Server (AS-CS) to buy or use one or more applications, using user location information obtained from UE OS 103. The AS-CS may send the user location information to LVS 113 to verify. LVS 113 then establishes a secured cellular connection 150 with AS-UE 105. The secured cellular connection 150 is based on a cellular address of UE 101 (e.g., the IP address of a cellular interface of UE 101) which thus prevents a fraudster from faking the requesting UE.

Note that UE 101 may include multiple wireline/wireless interfaces each with a corresponding IP address, including one or more of Institute of Electrical and Electronics Engineers (IEEE) 802.11 standards WiFi interface, Bluetooth interface, Near Field Communication (NFC) interface as well as the cellular interface couped to a cellular network. All of these wireline/wireless interfaces provide UE communication with other networks, but WiFi communication may use a local residential network, Bluetooth and NFC communication may be performed device-to-device without ever reaching a cellular network, and connection between a UE and a LVS in these ways may be intercepted by a fraudster, resulting in the LVS receiving fake location information. The secured cellular connection 150, on the other hand, leverages the cellular interface of UE 101 to the cellular network and is harder for a fraudster to manipulate.

LVS 113 may verify the location information provided by UE 101 through querying SCEF/NEF MONTE 111. Once the location information is confirmed, the Application Store Cloud Server (AS-CS) may provide the user requested one or more applications based on the location information and the users may experience the application differently depending on their locations. For example, two users of a cellular network register their cellphones in the United States (US) and Mexico, respectively. When they request the same video game from an application store on the AS-CS, they may be charged differently. The US user may be charged at a rate higher than the Mexico player, based on the discrepancy of disposable incomes in the two countries. The video game may provide different settings to users based on their registered locations in the cellular network. The US user may be provided avatars of American football stars while the Mexico user may be provided avatars of Mexican soccer stars. Additionally, different legal requirements of the two countries may dictate that different content in the same video game may be offered to the US and Mexico users (e.g., the user may be limited to content suitable to the user's age based on the national laws).

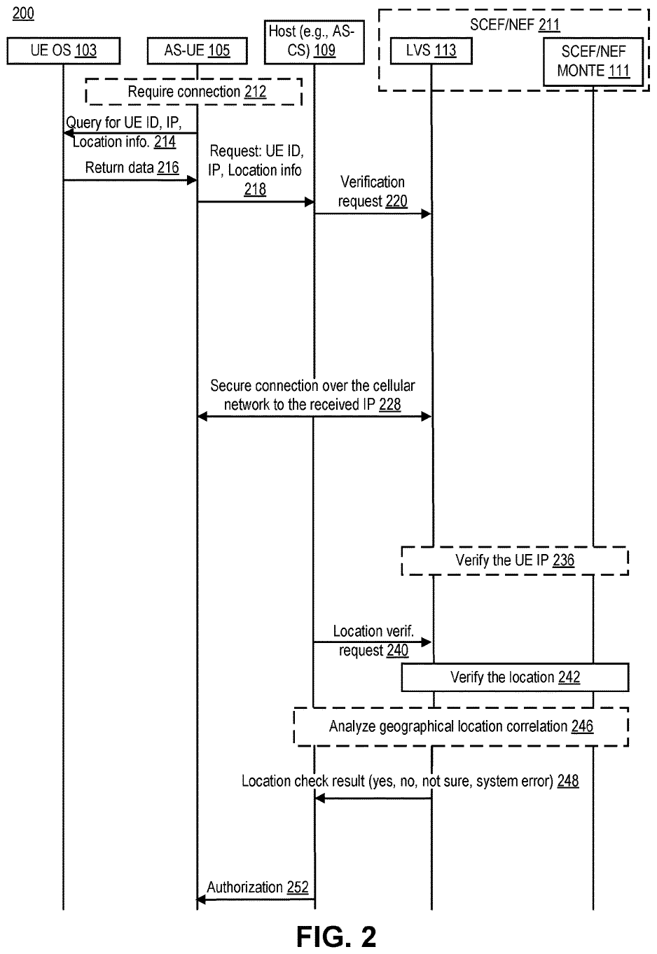

FIG. 2 illustrates the flow 200 to verify user equipment (UE) location based on a secured cellular connection per some embodiments. The entities involved in the flow operate in a system with a cellular network, as discussed in FIG. 1. Note that LVS 113 and SCEF/NEF MONTE 111 may be integrated and be implemented in a SCEF/NEF 211 that is implemented in a network node discussed herein.

At reference 212, a user of UE 101 may cause a request to set up a connection with host 109 to buy or use one or more applications from the Application Store Cloud Server (AS-CS) implemented by host 109. The request may be initiated by the user through a graphic user interface (GUI) or command line interface of UE 101 to AS-UE 105. The connection may be a cellular connection on the cellular network through which host 109 is reached, or a WiFi (or Bluetooth, NFC, etc.) connection to a gateway followed by a wireline/wireless connection from the gateway to host 109, or a wireline connection (e.g., copper/cable Ethernet connection) between UE 101 and the AS-CS. While UE 101 initiates the request to set up the connection as shown in the figure, the AS-CS or a third-party may initiate the request for the connection between UE 101 and the AS-CS in alternative embodiments.

To set up the connection with the AS-CS, AS-UE 105 transmits a query to UE OS 103 to obtain the UE ID, the IP address for a cellular connection in the cellular network, and the UE location information at reference 214. UE OS 103 responsively returns data to include the requested UE ID, the IP address, and the UE location information at reference 216. Note that the IP address of UE 101 is one of UE 101 to set up a cellular connection in the cellular network (in contrast to a connection through WiFi, Bluetooth, or NFC, for which the cellular network is not involved) and may be referred to as the cellular IP address of UE 101.

The UE ID may be the Mobile Station International Subscriber Directory Number (MSISDN), International Mobile Subscriber Identity (IMSI), International Mobile Equipment Identity (IMEI), or another ID that identifies UE 101. Note that UE ID may reveal the UE location as registered at the cellular network. For example, two digits of the MSISDN identifies the country of the UE as registered. The UE location information may indicate a GPS coordinate, a physical address/region, or other geographical location information of the UE.

AS-UE 105 then transmits a request to host 109 for the one or more applications at reference 218. The request indicates the obtained UE ID, the IP address, and the UE location information. Host 109 responsively transmits a verification request to LVS 113 at reference 220. In some embodiments, the verification request includes the obtained UE ID, the IP address, and the UE location information. LVS 113 then establishes a secured connection over the cellular network with AS-UE 105 at reference 228. The secured connection over the cellular network uses the IP address of a cellular interface of UE 101.

LVS 113 then coordinates the verification of the IP address obtained from UE OS 103 through querying SCEF/NEF MONTE 111 at reference 236. The verification is to confirm whether the IP address obtained from UE OS 103 matches a registered IP address of UE 101 in the cellular network. The verification may be based on the UE ID obtained at reference 216.

The verification may be performed in several ways. LVS 113 may transmit an IP address verification request (which may indicate the UE ID from UE OS 103) based on UE ID to SCEF/NEF MONTE 111, which retrieves and returns a corresponding IP address of UE 101 as registered to LVS 113. Based on the corresponding IP address, LVS 113 determines whether the corresponding IP address matches the IP address obtained from UE OS 103. Alternatively, LVS 113 may transmit the IP address verification request (which may indicate both the IP address and the UE ID from UE OS 103) to SCEF/NEF MONTE 111, which retrieves the corresponding IP address of UE 101 as registered to compare it with the IP address of UE 101 as indicated by the IP address verification request. SCEF/NEF MONTE 111 determines whether the two IP addresses match and then returns the determination to LVS 113. That is, the verification may be performed by LVS 113 or SCEF/NEF MONTE 111, and some embodiments may have a third-party entity to perform the determination.

In some embodiments, the entity checks a data structure (e.g., within or coupled to SCEF/NEF MONTE 111) that maintains the mapping between UE IDs and corresponding IP addresses. The data structure may be a map, a dictionary, a list, an array, a file, a table, or another data mapping representation in some embodiments. Through the data structure, the entity obtains the IP address of UE 101 as registered based on the UE ID of UE 101.

The UE IP address verification is optional in some embodiments, and it enhances the confidence for the subsequent location verification since the IP address verification confirms that the IP address genuinely belongs to UE 101, so UE 101 is more likely to be where it claims to be. When the UE IP address verification fails as the IP address obtained from UE OS 103 does not match the registered IP address of UE 101, the flow stops with the determination that the UE location determination fails in some embodiments. In some embodiments, the failure causes a rejection response from LVS 113 to the request to set up the connection with host 109 to buy or use the one or more applications. The failure may trigger a security alert to the operator of the AS-CS and/or LVS 113 in some embodiments. If the UE IP address verification succeeds, the flow continues.

At reference 240, the AS-CS transmits a location verification request to LVS 113. In some embodiments, the location verification request indicates the location of UE 101 based on the obtained UE location information.

At reference 242, LVS 113 and SCEF/NEF MONTE 111 verify the location of UE 101. The verification may be performed in several ways. LVS 113 may transmit the location verification request (indicating the UE ID in some embodiments) to SCEF/NEF MONTE 111, which retrieves and returns the corresponding location information to LVS 113. Based on the corresponding location information, LVS 113 verifies the UE location information obtained from UE OS 103. Alternatively, LVS 113 may transmit the location verification request (indicating both the UE ID and UE location information obtained from UE OS 103 in some embodiments) to SCEF/NEF MONTE 111, which retrieves the corresponding location information to compare it with the location of UE 101 as indicated by the location verification request. SCEF/NEF MONTE 111 makes the validity determination and then returns the determination to LVS 113.

The corresponding location information retrieved from SCEF/NEF MONTE 111 may include one or more of the following information: (1) the cell tower location identifier (ID) of the cell tower that is registered to provide services to UE 101, (2) the location of UE 101 as registered in the cellular network. The cell tower location ID indicates/maps to a geographical location (e.g., area/region/country) in which the corresponding cell tower resides. In some embodiments, when only cell tower ID is available, the entity to perform the verification (LVS 113, SCEF/NEF MONTE 111, or a third party depending on the embodiments) checks a data structure (e.g., within or coupled to SCEF/NEF MONTE 111) that maintains the mapping between cell IDs and geographical locations. Such checking may be referred to as database lookup as the data structure is often stored in a database. The data structure may be a map, a dictionary, a list, an array, a file, a table, or another data mapping representation in some embodiments. Through the data structure, the entity to perform the verification will obtain the geographical location based on the cell tower location ID.

The comparison of the location information from the two sources (UE OS 103 and SCEF/NEF MONTE 111) and obtaining the location check result may be straightforward in some embodiments. In other embodiments, the correlation of geographical location information needs to be analyzed at reference 246 to obtain the location check result. The geographical location information analysis compares the location information from the two sources and determines whether the two corresponding locations are close enough to determine that UE 101 is indeed at where it claims to be (as indicated by UE OS 103) and returns the location check result.

Either way, the location check result is returned to the Application Store Cloud Server (AS-CS). In some embodiments, the location check result includes one of the following:
(1) “Yes”—means that the location information from the two sources (UE OS 103 and SCEF/NEF MONTE 111) are close enough (or identical);
(2) “No”—means that the location information from the two sources corresponds to two different locations (e.g., two countries/regions); and
(3) “Not sure”—means that it is unclear whether the location information from the two sources matches. For example, a country/region may have numerous cell towers, and UE OS 103 indicating a location corresponding to a cell tower location that is not close enough to the cell tower location indicated in SCEF/NEF MONTE 111—other cell towers are closer so the location information provided by UE OS 103 could be fraudulent.

In some embodiments, the result of “not sure” may be represented by a numeric value referred to as a confidence level to indicate the level of uncertainty. The confidence value could be based on the geographic distance to the expected location based on the location information from SCEF/NEF MONTE 111, and/or take into account the distribution of cell towers in the cellular network (e.g., density and/or numbers of cell towers at given locations). For example, in a dense metropolitan deployment, it is not uncommon for the UE to attach to a cell that is not the geographically nearest cell, due to signal propagation physics, and the result of “not sure” may indicate a low/high numeric value that can be perceived close to “yes” thus such “not sure” may be treated as “yes” (e.g., “not sure” crossing the value over 0.7 (the threshold) is deemed as same as yes, when “yes” is 1 and “no” is “0”).

When the verification of the location can't be performed successfully (e.g., when connecting to SCEF/NEF MONTE 111 or retrieving information within results in a failure), a system error may be returned as the location check result. When that happens, the AS-CS may repeat the location verification request or escalate to operator of the cellular network or a third party to fix the issue and then retry the location verification request.

Based on the location check result, the AS-CS sends an authorization message to AS-UE 105 at reference 252. The authorization message may authorize/reject the corresponding UE 101 to a purchase price of the one or more applications, a particular setting (e.g., avatars), and/or a particular content. For example, if the location check result is “Yes” and the location corresponds to a lower price for the one or more applications, the lower price will be charged to the user of UE 101. If the location check result is “No” or “Not Sure” and the location obtained from UE OS 103 corresponds to the lower price, a higher price will be charged, or the AS-UE may deny the corresponding UE from using the one or more applications.

In some embodiments, LVS 113 verifies the identity of the application store that implements the Application Store Cloud Server (AS-CS), prior to accepting the verification request at reference 220. LVS 113 may check the registration of the application store, where the registration may include the domain used by the application store provider. LVS 113 may check the incoming verification requests using reverse domain name system (DNS) look-up: for example, the reverse DNS look-up result is server1.playstore.xyz.com for a verification request (where xyz.com belongs to an application store provider), and the verification request is verified to be valid as it matches *.playstore.xyz.com, registered for the application store provider.

Through the flow as shown herein, embodiments of the invention prevent a user (e.g., user 107) from fraudulently obtaining goods or services from the Application Store Cloud Server (AS-CS) by misrepresenting the user's true location, without compromising the user's privacy by revealing the user's location to the AS-CS. The user, through AS-UE 105, may send a request to set up a connection with host 109 to buy or use one or more applications from the AS-CS, the connection may be any wireline or wireless connection (e.g., as explained relating to reference 212), and such request may be authorized at reference 252 based on the secured cellular connection and subsequent verifications (e.g., as explained relating to reference 228 to 248).

### Exemplary Embodiments

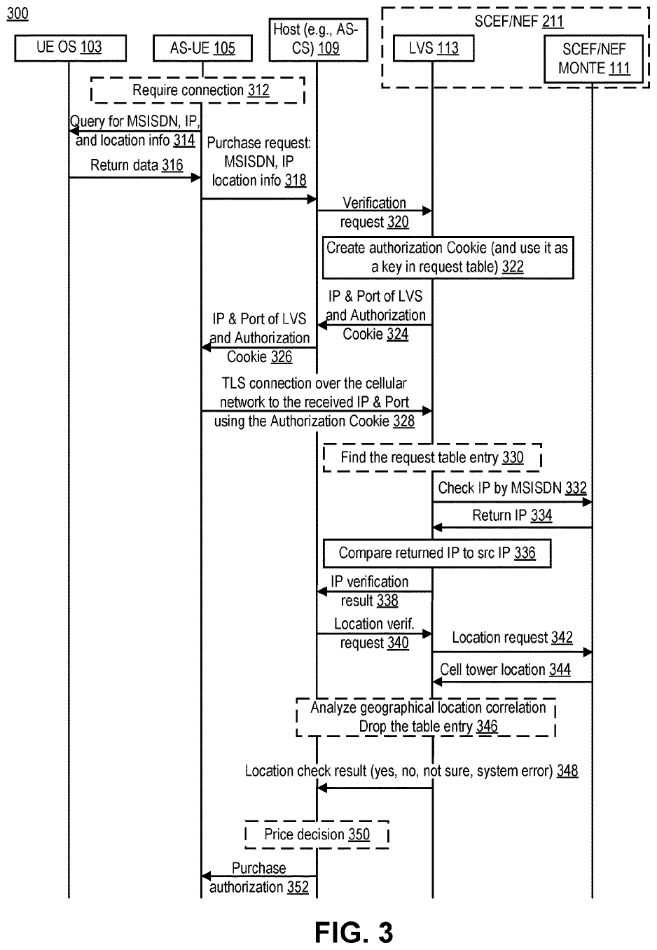

The secured cellular connection and subsequent verifications may be implemented in various ways. FIG. 3 illustrates the flow 300 to verify user equipment (UE) location based on a transport layer security (TLS) cellular connection per some embodiments. The entities involved in the flow are the same ones as in that of FIG. 2, and similar operations are included as well, and the discussion is thus about the differences between the two flows.

At reference 314, the MSISDN (one type of UE ID shown at reference 214) is requested in the query. The MSISDN of UE 101, along with the IP address of UE 101 for a cellular connection in the cellular network, and the UE location information of UE 101 will be returned at reference 316 responsively. The returned data is then transmitted to the AS-CS at reference 318, where the AS-CS transmits the verification request to LVS 113 at reference 320.

At reference 322, LVS 113 creates an authorization cookie for a secured connection between AS-UE 105 and LVS 113. The authorization cookie may be a HTTP cookie to authenticate a request and maintain session information on a server, the Application Store Cloud Server (AS-CS), over the stateless HTTP protocol in some embodiments. The HTTP cookie is a small piece of data that the server creates and sends to a user's web browser (e.g., a GUI of UE 101) to authenticate AS-UE 105. LVS 113 may create a pending verification request entry record in a request table to track that there is a pending verification request in some embodiments. The request table may include multiple entry records, each tracking the status of a verification request (e.g., pending or completed). The authorization cookie may be used as a key in the subsequent steps in the location verification process in some embodiments.

LVS 113 returns a 3-tuple in a message to the AS-CS at reference 324, the 3-tuple including an IP address of LVS 113 through which LVS 113 may establish a connection over the cellular network (e.g., the IP address of a cellular interface of LVS 113), a port number that identifies an IP port through which the secured connection between LVS 113 and AS-UE 105 may be established, and the authorization cookie for the verification request. In some embodiments, the IP address of LVS 113 and the port number are reachable by AS-UE 105 through the cellular network only. The AS-CS then forwards the 3-tuple to AS-UE 105 at reference 326.

AS-UE 105 then sets up a transport layer security (TLS) connection with LVS 113 over the cellular network to the received IP address and port using the authorization cookie based on the 3-tuple at reference 328. The TLS connection over the cellular network uses the IP address of a cellular interface of UE 101 as discussed herein above. The cellular TLS connection is encrypted and decrypted based on the authorization cookie and used as a transport for Representational State Transfer (REST) messages. While TLS is used in this example, another embodiment may establish a secured cellular connection over the cellular network between LVS 113 and AS-UE 105 that uses the IP address and the IP port.

When the pending verification request entry record was created in a request table earlier in the flow (e.g., at reference 322), LVS 113 locates the corresponding verification request entry in the request table and confirms that the verification request is still pending at reference 330.

At reference 332, LVS 113 checks the IP address obtained from UE OS 103 at reference 316 by querying SCEF/NEF MONTE 111 based on the MSISDN of UE 101 (the request to check from LVS 113 may indicate the MSISDN) at reference 332. SCEF/NEF MONTE 111 may retrieve and return a corresponding IP address of UE 101 as registered to LVS 113 at reference 334 based on the MSISDN. SCEF/NEF MONTE 111 may check the data structure that maintains the mapping between MSISDNs and corresponding IP addresses, an embodiment of the data structure that maintains the mapping between UE IDs and corresponding IP addresses.

At reference 336, LVS 113 compares the IP address obtained from UE OS 103 (referred to as the source IP address) and the returned IP address of UE 101 from SCEF/NEF MONTE 111 and determines whether they match. The IP address obtained from UE OS 103 may be referred to as the source IP address, as it is the cellular source IP address for the TLS connection from AS-UE 105 to the AS-CS. The result is returned to the AS-CS at reference 338 as the IP verification result message. When/if the IP address does not match, LVS 113 sends a rejection response to AS-UE 105 responsive to the request to set up the connection (see reference 312). The flow 300 stops and the failure may trigger a security alert to the operator of the AS-CS and/or LVS 113 in some embodiments.

Once the IP address matches, the AS-CS transmits a location verification request to LVS 113 at reference 340. The location verification request indicates the location of UE 101 based on the obtained UE location information in some embodiments.

At reference 342, LVS 113 transmits a location request to SCEF/NEF MONTE 111, where the location request indicates the MSISDN of UE 101. SCEF/NEF MONTE 111 retrieves and returns the corresponding cell tower location information to LVS 113 based on the MSISDN of UE 101 at reference 344. In some embodiments, the returned location information indicates the location of the cell tower that is registered to provide services to UE 101.

At reference 346, LVS 113 analyzes the geographical location correlation between the obtained UE location information from UE OS 103 and the returned cell tower location information from SCEF/NEF MONTE 111, and the analysis is similar to the one discussed at reference 246. In some embodiments, the pending verification request entry record created earlier (e.g., at reference 322) is dropped from the request table after the geographical location correlation analysis is completed.

At reference 348, the location check result is returned to the AS-CS, similar to reference 248. The AS-CS determines what price to charge the user 107 of UE 101 at reference 350 and provide the purchase authorization at reference 352. For example, if the location check result is “Yes” and the location corresponds to a lower price for the one or more applications, the lower price will be charged to the user of UE 101. If the location check result is “No” or “Not Sure” and the location obtained from UE OS 103 corresponds to the lower price, a higher price will be charged, or the AS-UE may deny the corresponding UE from using the one or more applications.

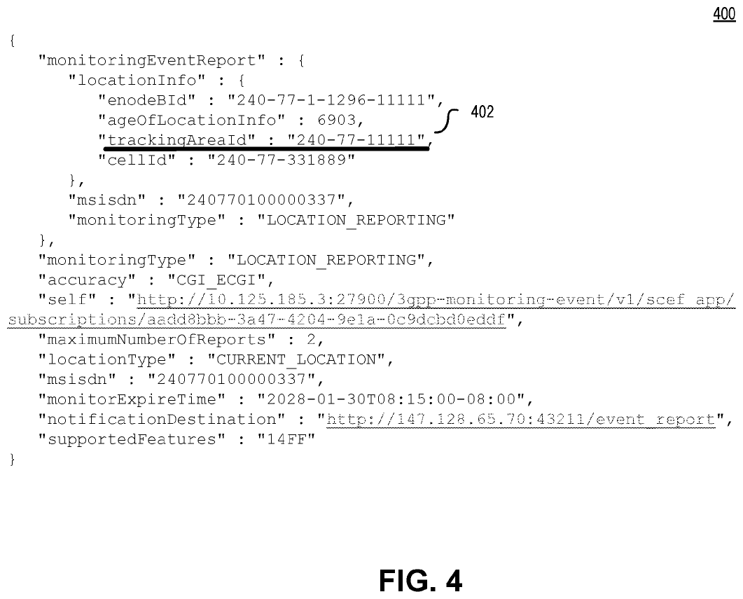

FIG. 4 illustrates a response 400 from Network Exposure Function/Service Capability Exposure Function (NEF/SCEF) Monitoring Events (MONTE) per some embodiments. The response from the SCEF/NEF MONTE is a monitoring event report, which is in response to a location request (e.g., the location request at reference 342). The monitoring event report is provided as a part of SCEF/NEF location services, and it includes location information datasets, such as a tracking area ID of a cell tower that provides service to the corresponding UE, “trackingAreaID” as shown at reference 402. The tracking area ID of a cell tower corresponds to a geographical area of the cell tower, which is used to match the indicated UE location information of the corresponding UE (e.g., the one obtained from US OS 103 at references 216 and 316).

The tracking area ID may be obtained from SCEF/NEF MONTE based on the UE ID of the corresponding UE. The corresponding geographical area of the cell tower is then compared to the UE location derived from UE OS 103 to obtain the location check result, e.g., “yes,” “no,” “not sure” as discussed herein.

### Operations Per Some Embodiments

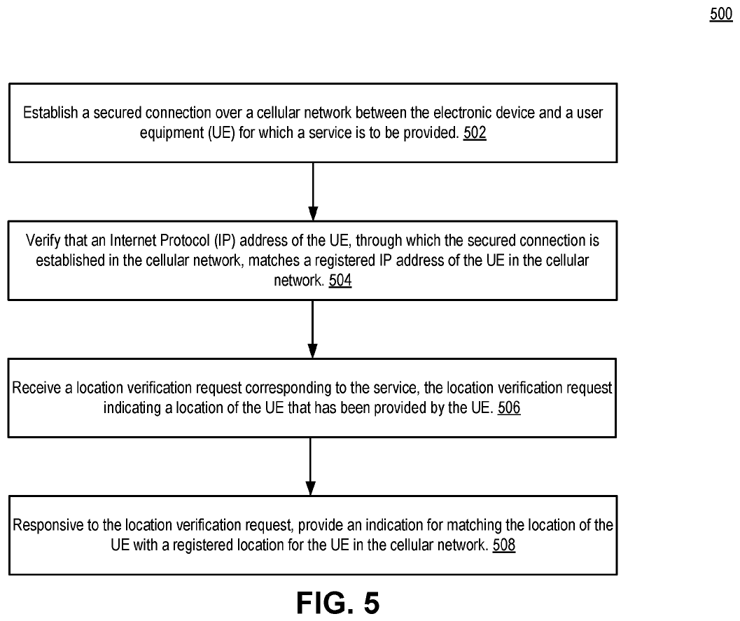

FIG. 5 is a flow diagram 500 illustrating the operations to verify user equipment (UE) location based on a secured cellular connection per some embodiments. The operations are performed by an electronic device that implements LVS 113 discussed herein above.

At reference 502, a secured connection is established over a cellular network between the electronic device and a user equipment (UE) for which a service is to be provided. The service may be buying or using one or more applications discussed herein above. The one or more applications are to be offered by an application store provider that operates an application store, which is often offered through an application server (e.g., the Application Store Cloud Server (AS-CS) discussed herein above). In some embodiments, the secured connection is a transport layer security connection. The secured cellular connection has been explained herein above relating to FIGS. 1 to 3.

At reference 504, the electronic device verifies that an Internet Protocol (IP) address of the UE, through which the secured connection is established in the cellular network, matches a registered IP address of the UE in the cellular network. The cellular IP address of the UE is the IP address of a cellular interface of the UE in some embodiments. The verification of the IP address is discussed herein above, e.g., references 236 and 332 to 338.

At reference 506, the electronic device receives a location verification request corresponding to the service, the location verification request indicating a location of the UE that has been provided by the UE. At reference 508, the electronic device provides an indication for matching the location of the UE with a registered location for the UE in the cellular network responsive to the location verification request. The indication may be one selected from a set including ones explained relating to references 248 and 348.

In some embodiments, establishing the secured connection is responsive to the application server providing, to the UE, an IP address of the electronic device through which the electronic device is to establish the secured connection with the UE, and wherein the IP address of the electronic device is reachable by the UE through the cellular network only.

In some embodiments, the application server provides an authorization cookie to the UE along with the IP address of the electronic device, and where the authorization cookie is generated by the electronic device and authentication of the UE in the secured connection is based on the authorization cookie. The authentication is discussed relating to references 322 to 328.

In some embodiments, the electronic device transmits a message to the application server based on receipt of a request to verify the IP address of the UE, the request indicating a UE identifier of the UE, the IP address of the UE, and the location of the UE, and the message indicating the authorization cookie. Embodiments of the request include the one discussed relating to references 220 and 320, and one embodiment of the message is the one discussed relating to reference 324.

In some embodiments, the UE identifier is one of a Mobile Station International Subscriber Directory Number (MSISDN) of the UE and an International Mobile Subscriber Identity (IMSI) of the UE.

In some embodiments, verification of the IP address of the UE is through a first inquiry to a network exposure function (NEF) or a Service Capability Exposure Function (SCEF) based on a UE identifier of the UE. The verification is discussed relating to references 236 and 332 to 338.

In some embodiments, the location verification request is transmitted to the electronic device responsive to a confirmation message from the electronic device indicating that the IP address of the UE matches the registered IP address of the UE in the cellular network (e.g., the confirmation message at reference 338).

In some embodiments, providing the indication is through a second inquiry to a NEF or SCEF based on a UE identifier of the UE. In some embodiments, the second inquiry results in a response from the NEF or SCEF providing one or more of (1) a cell tower location identifier that indicates a location of a cell tower registered to provide one or more services to the UE, and (2) the registered location for the UE in the cellular network. In some embodiments, the indication is based on at least the location of the UE that has been provided by the UE, the response from the SCEF or NEF, and distribution of cell towers in the cellular network.

In some embodiments, the application server determines a price to pay for providing the service to the UE based on the indication for matching the location of the UE with the registered location for the UE in the cellular network. The price determination is discussed relating to references 252, and 350 to 352.

In some embodiments, the indication for matching the location of the UE with the registered location for the UE in the cellular network is provided with a confidence level of the indication.

In some embodiments, the location verification request is tracked as an entry in a request table, and wherein the entry is dropped upon determination of matching between the location of the UE and the registered location for the UE in the cellular network.

These embodiments of the invention provide methods, systems, and storage medium to verify a UE location based on a cellular connection. The electronic device (e.g., LVS 113) uses SCEF/NEF MONTE Location services to determine the UE location and cell tower locations. This is much more difficult to spoof since it relies on location information provided by the cellular network.

### Devices Implementing Embodiments of the Invention

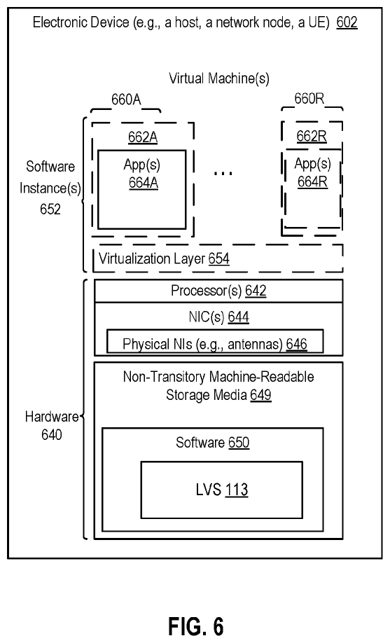

FIG. 6 illustrates an electronic device to verify user equipment (UE) location based on a secured cellular connection per some embodiments. The electronic device may be a host in a cloud system, or a network node/UE in a wireless/wireline network, and the operating environment and further embodiments of the host, the network node, and the UE are discussed in more details herein below. The electronic device 602 may be implemented using custom application-specific integrated circuits (ASICs) as processors and a special-purpose operating system (OS), or common off-the-shelf (COTS) processors and a standard OS. In some embodiments, the electronic device 602 implements LVS 113.

The electronic device 602 includes hardware 640 comprising a set of one or more processors 642 (which are typically COTS processors or processor cores or ASICs) and physical NIs 646, as well as non-transitory machine-readable storage media 649 having stored therein software 650. During operation, the one or more processors 642 may execute the software 650 to instantiate one or more sets of one or more applications 664A-R. While one embodiment does not implement virtualization, alternative embodiments may use different forms of virtualization. For example, in one such alternative embodiment, the virtualization layer 654 represents the kernel of an operating system (or a shim executing on a base operating system) that allows for the creation of multiple instances 662A-R called software containers that may each be used to execute one (or more) of the sets of applications 664A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 654 represents a hypervisor (sometimes referred to as a virtual machine monitor (VMM)) or a hypervisor executing on top of a host operating system, and each of the sets of applications 664A-R run on top of a guest operating system within an instance 662A-R called a virtual machine (which may in some cases be considered a tightly isolated form of software container) that run on top of the hypervisor-the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 640, directly on a hypervisor (in which case the unikernel is sometimes described as running within a LibOS virtual machine), or in a software container, embodiments can be implemented fully with unikernels running directly on a hypervisor represented by virtualization layer 654, unikernels running within software containers represented by instances 662A-R, or as a combination of unikernels and the above-described techniques (e.g., unikernels and virtual machines both run directly on a hypervisor, unikernels, and sets of applications that are run in different software containers).

The software 650 contains LVS 113 that performs operations described with reference to operations as discussed relating to FIGS. 1 to 5. LVS 113 may be instantiated within the applications 664A-R. The instantiation of the one or more sets of one or more applications 664A-R, as well as virtualization if implemented, are collectively referred to as software instance(s) 652. Each set of applications 664A-R, corresponding virtualization construct (e.g., instance 662A-R) if implemented, and that part of the hardware 640 that executes them (be it hardware dedicated to that execution and/or time slices of hardware temporally shared), forms a separate virtual electronic device 660A-R.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). The NI is shown as network interface card (NIC) 644. The physical network interface 646 may include one or more antenna of the electronic device 602. An antenna port may or may not correspond to a physical antenna. The antenna comprises one or more radio interfaces.

### A Wireless Network Per Some Embodiments

FIG. 7 illustrates an example of a communication system 700 per some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

### UE Per Some Embodiments

FIG. 8 illustrates a UE 800 per some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

### Network Node Per Some Embodiments

FIG. 9 illustrates a network node 900 per some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

### Host Per Some Embodiments

FIG. 10 is a block diagram of a host 1000, which may be an embodiment of the host 716 of FIG. 7, per various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

### Virtualization Environment Per Some Embodiments

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g., such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

### Communication Among Host, Network Node, and UE Per Some Embodiments

FIG. 12 illustrates a communication diagram of a host 1202 communicating via a network node 1204 with a UE 1206 over a partially wireless connection per some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

### Terms

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other.

An electronic device (such as the electronic device 602) stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals—such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

The terms “module,” “logic,” and “unit” used in the present application, may refer to a circuit for performing the function specified. In some embodiments, the function specified may be performed by a circuit in combination with software such as by software executed by a general-purpose processor.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method to be implemented in an electronic device, comprising:
establishing a secured connection over a cellular network between the electronic device and a user equipment (UE) for which a service is to be provided;
verifying that an Internet Protocol (IP) address of the UE, through which the secured connection is established in the cellular network, matches a registered IP address of the UE in the cellular network;
receiving a location verification request corresponding to the service, the location verification request indicating a location of the UE that has been provided by the UE; and
responsive to the location verification request, providing an indication for matching the location of the UE with a registered location for the UE in the cellular network.

2. The method of claim 1, wherein establishing the secured connection is responsive to an application server providing, to the UE, an IP address of the electronic device through which the electronic device is to establish the secured connection with the UE, and wherein the IP address of the electronic device is reachable by the UE through the cellular network only.

3. The method of claim 2, wherein the application server provides an authorization cookie to the UE along with the IP address of the electronic device, and wherein the authorization cookie is generated by the electronic device and authentication of the UE in the secured connection is based on the authorization cookie.

4. The method of claim 3, wherein the electronic device transmits a message to the application server based on receipt of a request to verify the IP address of the UE, the request indicating a UE identifier of the UE, the IP address of the UE, and the location of the UE, and the message indicating the authorization cookie.

5. The method of claim 4, wherein the UE identifier is one of a Mobile Station International Subscriber Directory Number (MSISDN) of the UE and an International Mobile Subscriber Identity (IMSI) of the UE.

6. The method of claim 1, wherein verification of the IP address of the UE is through a first inquiry to a network exposure function (NEF) or a Service Capability Exposure Function (SCEF) based on a UE identifier of the UE.

7. The method of claim 1, wherein the location verification request is transmitted to the electronic device responsive to a confirmation message from the electronic device indicating that the IP address of the UE matches the registered IP address of the UE in the cellular network.

8. The method of claim 1, wherein providing the indication is through a second inquiry to a network exposure function (NEF) or Service Capability Exposure Function (SCEF) based on a UE identifier of the UE.

9. The method of claim 8, wherein the second inquiry results in a response from the NEF or SCEF providing one or more of:
a cell tower location identifier that indicates a location of a cell tower registered to provide one or more services to the UE, and
the registered location for the UE in the cellular network.

10. The method of claim 9, wherein the indication is based on at least the location of the UE that has been provided by the UE, the response from the NEF or SCEF, and distribution of cell towers in the cellular network.

11. The method of claim 1, wherein an application server determines a price to pay for providing the service to the UE based on the indication for matching the location of the UE with the registered location for the UE in the cellular network.

12. The method of claim 1, wherein the indication for matching the location of the UE with the registered location for the UE in the cellular network is provided with a confidence level of the indication.

13. The method of claim 1, wherein the location verification request is tracked as an entry in a request table, and wherein the entry is dropped upon determination of matching between the location of the UE and the registered location for the UE in the cellular network.

14. The method of claim 1, wherein the secured connection is a transport layer security connection.

15. An electronic device, comprising:
a processor and non-transitory machine-readable storage medium that provides instructions that, when executed by the processor, are capable of causing the processor to perform:
establishing a secured connection over a cellular network between the electronic device and a user equipment (UE) for which a service is to be provided;
verifying that an Internet Protocol (IP) address of the UE, through which the secured connection is established in the cellular network, matches a registered IP address of the UE in the cellular network;
receiving a location verification request corresponding to the service, the location verification request indicating a location of the UE that has been provided by the UE; and
responsive to the location verification request, providing an indication for matching the location of the UE with a registered location for the UE in the cellular network.

16. The electronic device of claim 15, wherein establishing the secured connection is responsive to an application server providing, to the UE, an IP address of the electronic device through which the electronic device is to establish the secured connection with the UE, and wherein the IP address of the electronic device is reachable by the UE through the cellular network only.

17.-20. (canceled)

21. The electronic device of claim 15, wherein the location verification request is transmitted to the electronic device responsive to a confirmation message from the electronic device indicating that the IP address of the UE matches the registered IP address of the UE in the cellular network.

22.-24. (canceled)

25. The electronic device of claim 15, wherein an application server determines a price to pay for providing the service to the UE based on the indication for matching the location of the UE with the registered location for the UE in the cellular network.

26. The electronic device of claim 15, wherein the indication for matching the location of the UE with the registered location for the UE in the cellular network is provided with a confidence level of the indication.

27.-28. (canceled)

29. A non-transitory machine-readable storage medium that provides instructions that, when executed by a processor, are capable of causing the processor to perform:
establishing a secured connection over a cellular network between an electronic device and a user equipment (UE) for which a service is to be provided;
verifying that an Internet Protocol (IP) address of the UE, through which the secured connection is established in the cellular network, matches a registered IP address of the UE in the cellular network;
receiving a location verification request corresponding to the service, the location verification request indicating a location of the UE that has been provided by the UE; and
responsive to the location verification request, providing an indication for matching the location of the UE with a registered location for the UE in the cellular network.
